(19) United States
(12) Patent Application Publication
(10) Pub. No.: US 2020/0339256 A1
(43) Pub. Date: Oct. 29, 2020

(54) Vertical Takeoff and Landing System

(71) Applicant: Bell Helicopter Textron Inc., Fort Worth, TX (US)

(72) Inventor: Steven Ray Ivans, Ponder, TX (US)

(21) Appl. No.: 16/398,222

(22) Filed: Apr. 29, 2019

(51) Int. Cl. B64C 29/02; B64C 27/08

(52) U.S. Cl. CPC B64C 29/02; B64C 27/08

(57) ABSTRACT

Various implementations described herein are directed to a vertical takeoff and landing system. In one implementation, the vertical takeoff and landing system includes a carriage. The carriage includes a thrust component configured to provide vertical and/or horizontal thrust for the carriage and one or more housings configured to receive an aircraft in a joined configuration of the carriage and the aircraft.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Aircraft having vertical takeoff and landing (VTOL) capability sacrifice speed and maneuverability due to the extra weight of the VTOL system included in the aircraft. Designing an aircraft that can fly with higher speeds, greater maneuverability and greater cruising efficiency presents challenges when VTOL components must be included in the aircraft design.

### SUMMARY

Described herein are various implementations of a vertical takeoff and landing system. In one implementation, the vertical takeoff and landing system includes a carriage. The carriage includes a thrust component configured to provide vertical and/or horizontal thrust for the carriage and one or more housings configured to receive an aircraft in a joined configuration of the carriage and the aircraft.

The carriage may include a lift component configured to provide lift for the carriage.

The carriage may include a plurality of struts that serve as landing gear, provide ground clearance for the carriage or both.

In one implementation, the one or more housings include one or more coupling mechanisms configured to engage with the aircraft. The one or more coupling mechanisms may be a wench assembly. The wench assembly may include a reel, a line coupled to the reel and a coupling member coupled to the line. The coupling member may be configured to engage with the aircraft.

In one implementation, the coupling member may include a plurality of arms configured to engage with a plurality of grooves of a coupling element coupled to the aircraft.

In one implementation, the reel of the wench assembly rotates to pull the aircraft into the joined configuration with the carriage. The one or more housings may include one or more locking components configured to engage with the aircraft when the carriage is in the joined configuration with the aircraft.

In one implementation, the one or more housings can be configured to receive the aircraft when the aircraft flies into the joined configuration with the carriage. The one or more housings may include one or more locking components configured to engage with the aircraft when the carriage is in the joined configuration with the aircraft.

Also described herein is a method for providing carriage-based vertical takeoff. In one implementation, an upward vertical flight mode is initiated for a carriage and an aircraft in a joined configuration. The joined configuration is transitioned to a horizontal flight mode. The carriage releases the aircraft from the joined configuration.

In one implementation, the carriage can be transitioned to a downward vertical flight mode and the carriage can land while in the downward vertical flight mode.

In one implementation, thrust for the upward vertical flight mode may be provided by the carriage in the joined configuration.

In one implementation, thrust for the upward vertical flight mode may be provided by the carriage and the aircraft in the joined configuration.

Also described herein is a method for providing carriage-based vertical landing. An upward vertical flight mode is initiated by a carriage. The carriage is transitioned to a horizontal flight mode. The carriage receives an aircraft in a joined configuration of the carriage and the aircraft while the aircraft and the carriage are in respective horizontal flight modes. The joined configuration is transitioned to a downward vertical flight mode. The joined configuration lands while in the downward vertical flight mode.

In one implementation, the carriage can receive the aircraft in the joined configuration using a wench to pull the aircraft into the joined configuration.

In one implementation, the carriage can receive the aircraft in the joined configuration when the aircraft flies into the joined configuration.

In one implementation, thrust for the downward vertical flight mode can be provided by the carriage.

In one implementation, thrust for the downward vertical flight mode can be provided by the carriage and the aircraft.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a perspective view of a VTOL carriage in accordance with implementations of various techniques described herein.

FIG. 2 illustrates a front view of the VTOL carriage of FIG. 1 in accordance with implementations of various techniques described herein.

FIG. 3 illustrates a side view of the VTOL carriage of FIG. 1 in accordance with implementations of various techniques described herein.

FIG. 4 illustrates a top view of the VTOL carriage of FIG. 1 in accordance with implementations of various techniques described herein.

FIG. 5 illustrates a perspective view of an aircraft in accordance with implementations of various techniques described herein.

FIG. 6 illustrates a top view of the aircraft of FIG. 5 in accordance with implementations of various techniques described herein.

FIG. 7 illustrates a front view of the aircraft of FIG. 5 in accordance with implementations of various techniques described herein.

FIG. 8 illustrates a side view of the aircraft of FIG. 5 in accordance with implementations of various techniques described herein.

FIG. 9 illustrates a perspective view of the VTOL carriage of FIG. 1 and the aircraft of FIG. 5 in a joined configuration in accordance with implementations of various techniques described herein.

FIG. 10 illustrates a front view of the VTOL carriage of FIG. 1 and the aircraft of FIG. 5 in a joined configuration in accordance with implementations of various techniques described herein.

FIG. 11 illustrates a side view of the VTOL carriage of FIG. 1 and the aircraft of FIG. 5 in a joined configuration in accordance with implementations of various techniques described herein.

FIG. 12 illustrates a top view of the VTOL carriage of FIG. 1 and the aircraft of FIG. 5 in a joined configuration in accordance with implementations of various techniques described herein.

FIG. 13 illustrates a perspective view of the VTOL carriage of FIG. 1 engaged with the aircraft of FIG. 5 in accordance with implementations of various techniques described herein.

FIG. 14 illustrates how a coupling mechanism can be coupled to a coupling element in accordance with implementations of various techniques described herein.

FIG. 15 illustrates the coupling mechanism once the coupling with the coupling element is complete in accordance with implementations of various techniques described herein.

FIG. 16 illustrates the VTOL carriage of FIG. 1 engaged with the aircraft of FIG. 5 prior to joining the VTOL carriage and the aircraft in accordance with implementations of various techniques described herein.

FIG. 17 illustrates the VTOL carriage of FIG. 1 engaged with the aircraft of FIG. 5 after joining the VTOL carriage and the aircraft in accordance with implementations of various techniques described herein.

FIG. 18 illustrates an outbound transition in accordance with implementations of various techniques described herein.

FIG. 19 illustrates a diagram of an outbound transition method in accordance with implementations of various techniques described herein.

FIG. 20 illustrates an inbound transition in accordance with implementations of various techniques described herein.

FIG. 21 illustrates a diagram of an inbound transition method in accordance with implementations of various techniques described herein.

FIG. 22 illustrates a computer system in accordance with implementations of various techniques described herein.

### DETAILED DESCRIPTION

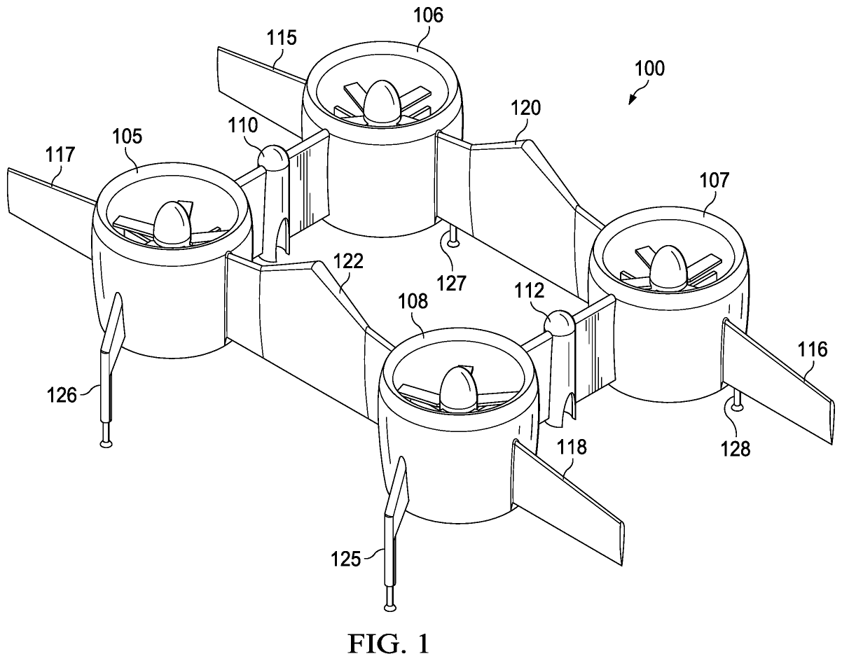

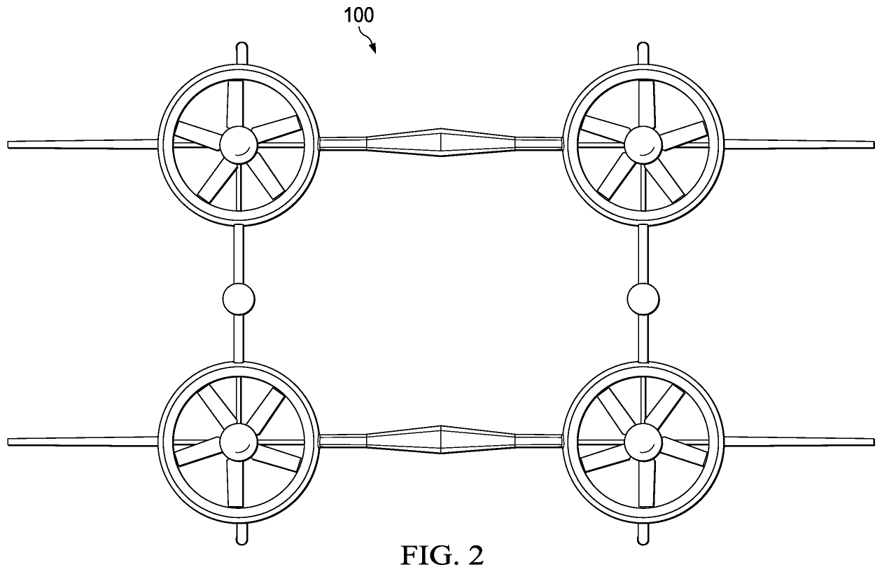

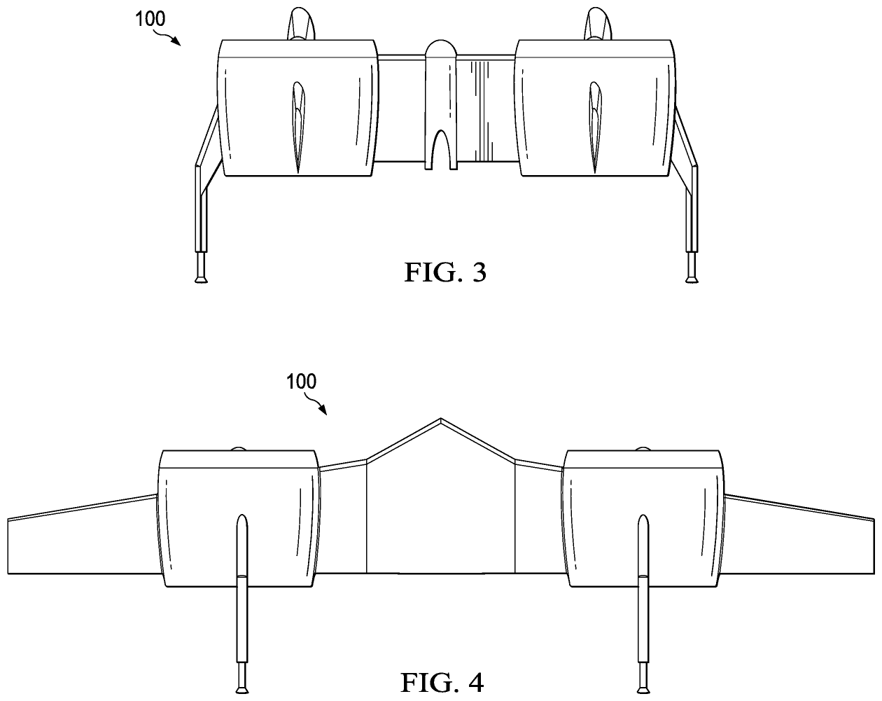

FIG. 1 illustrates a perspective view of a VTOL carriage 100 according to one implementation. FIG. 2 illustrates a front view of carriage 100. FIG. 3 illustrates a side view of carriage 100. FIG. 4 illustrates a top view of carriage 100. Carriage 100 includes a plurality of lift fans 105, 106, 107, 108, fins/wings 115, 116, 117, 118, center body wings 120, 122, housings 110, 112, and struts 125, 126, 127, 128.

Although four lift fans 105, 106, 107, 108 are shown, the number of lift fans may be more or less, where the number of fans utilized and/or the particular geometric configuration of the fan(s) depends on the size of the fan itself and the amount of lift and/or thrust suitable for a particular implementation. Lift fans 105, 106, 107, 108 may generally be described as a thrust component. The thrust component may include lift fans, jets, open propellers or any other component capable of generating thrust.

Wings 115, 116, 117, 118 and center body wings 120, 122 may also provide lift for the carriage. As such, wings 115, 116, 117, 118 and center body wings 120, 122 may generally be described as lift components. Although the implementation shown in FIG. 1 shows four wings 115, 116, 117, 118 and two center body wings 120, 122, the number of wings and/or center body wings can be varied depending on the amount of lift suitable for a particular implementation.

Struts 125, 126, 127, 128 can serve as landing gear for the carriage 100. Struts 125, 126, 127, 128 additionally provide ground clearance for the carriage 100. Struts 125, 126, 127, 128 may also provide ground clearance for an aircraft coupled to the carriage, e.g., when the carriage 100 accommodates an aircraft in a tail sitter configuration. The number of struts can be varied depending on the particular carriage implementation.

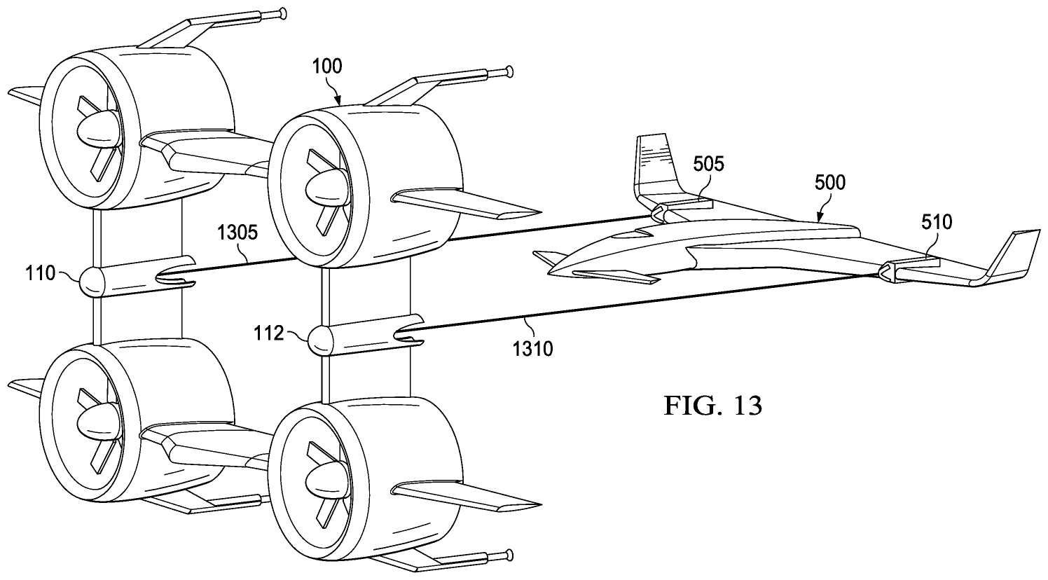

Housings 110, 112 include coupling mechanisms and/or locking components for coupling the carriage 100 to an aircraft. Both the coupling mechanisms and the locking components are described in further detail below with respect to FIGS. 13 to 17. The number of housings may be varied depending on the particular carriage implementation.

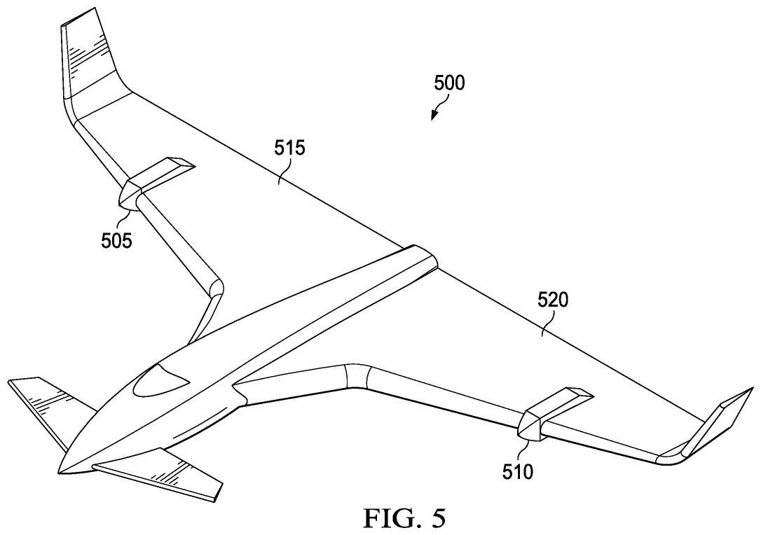

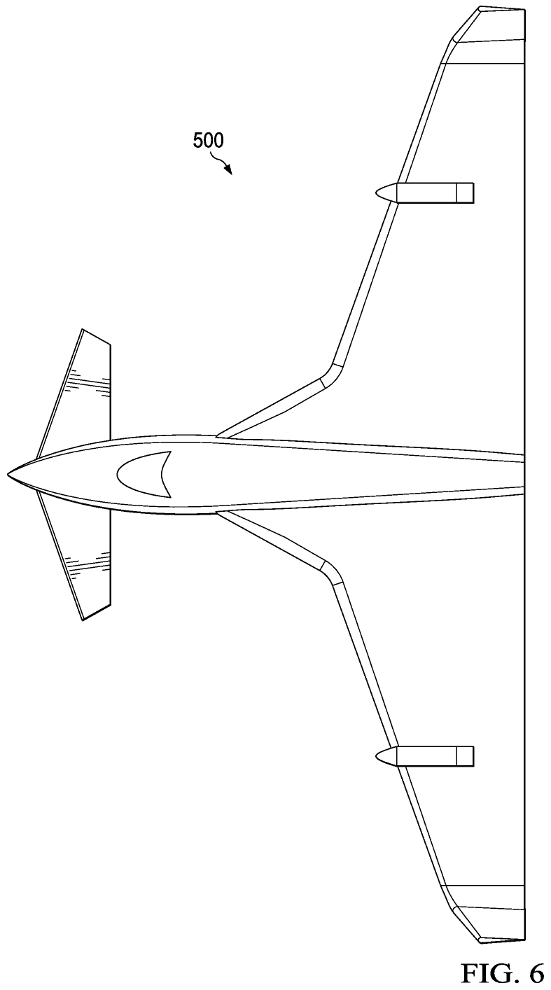

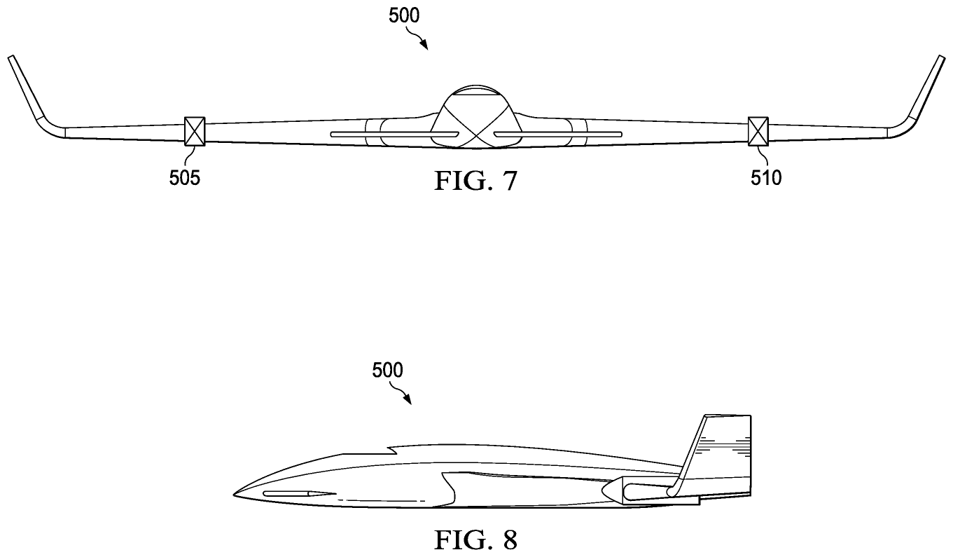

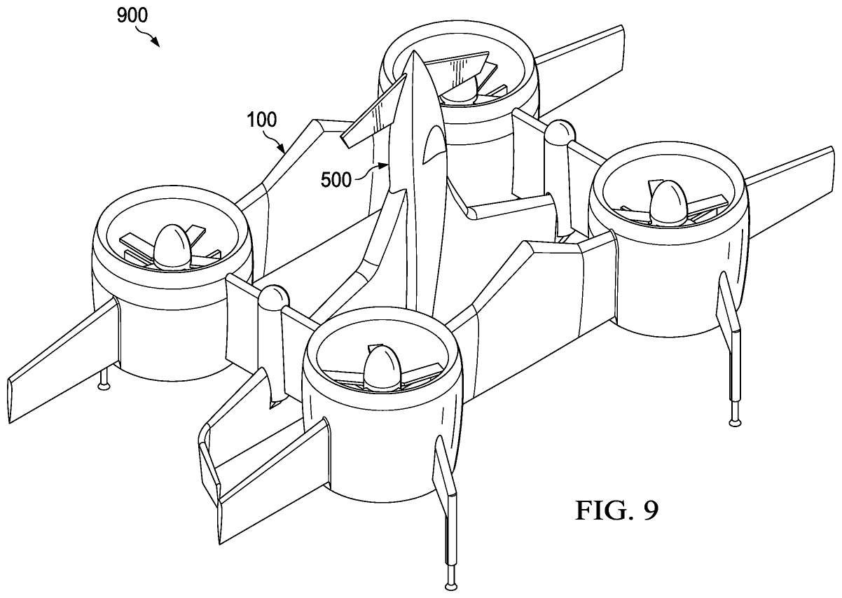

FIG. 5 illustrates a perspective view of an aircraft 500. FIG. 6 illustrates a top view of the aircraft 500. FIG. 7 illustrates a front view of the aircraft 500. FIG. 8 illustrates a side view of the aircraft 500. Aircraft 500 includes coupling elements 505, 510 coupled to wings 515, 520. Coupling elements 505, 510 are used to couple the aircraft to carriage 100. Although in this particular implementation, two coupling elements are shown, one or more coupling elements may be utilized. In addition, the coupling element(s) may be attached to the aircraft in locations other than wings 515, 520. For example, the coupling element(s) may be coupled to a nose, undercarriage, or any other suitable location on an aircraft.

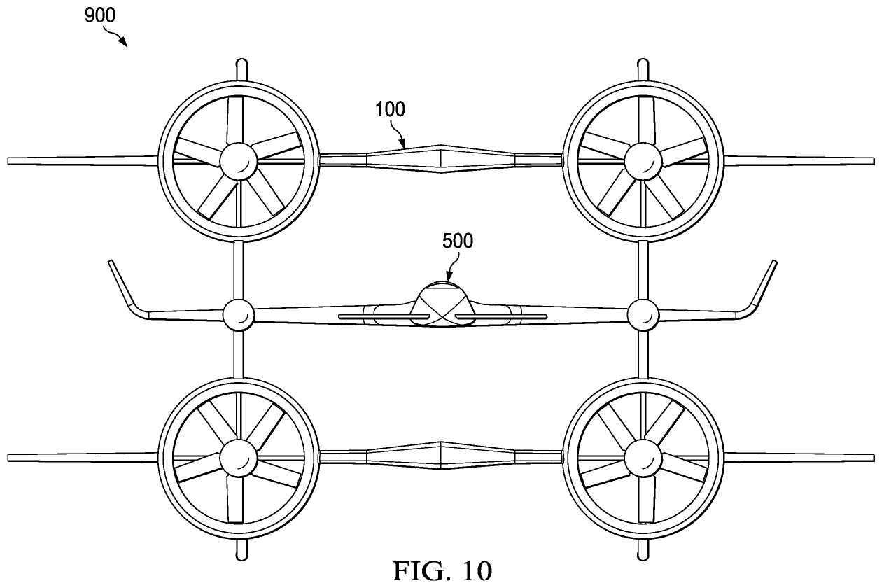

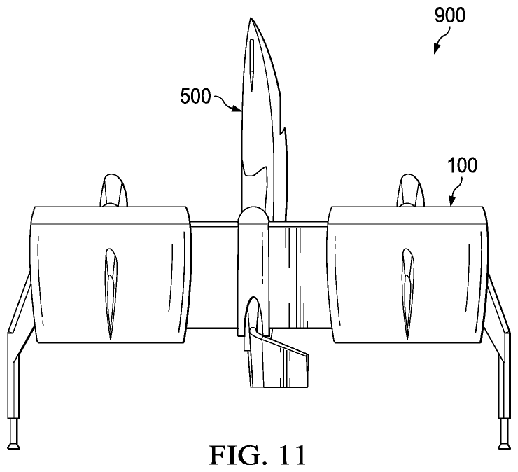

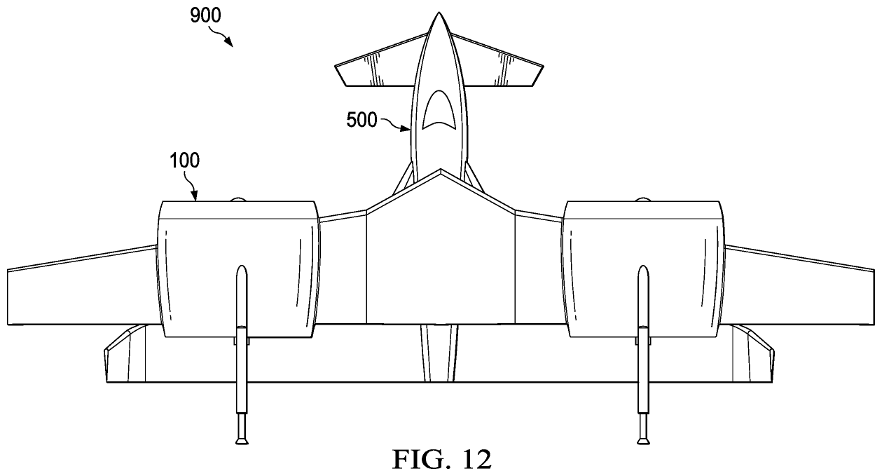

FIG. 9 illustrates a perspective view of carriage 100 and aircraft 500 in a joined configuration 900. FIG. 10 illustrates a front view of carriage 100 and aircraft 500 in the joined configuration 900. FIG. 11 illustrates a side view of carriage 100 and aircraft 500 in the joined configuration 900. FIG. 12 illustrates a top view of carriage 100 and aircraft 500 in the joined configuration 900. Aircraft 500 may be any type of aircraft, including, but not limited to, a jet, a fan-based aircraft, or a propeller-based aircraft. Although carriage 100 is described above as including wings 115, 116, 117, 118 and center body wings 120, 122, certain implementations of carriage 100 may not include any wing surfaces and rely on aircraft 500 to provide the lift component and provide lift for the joined configuration 900 of the carriage 100 and aircraft 500.

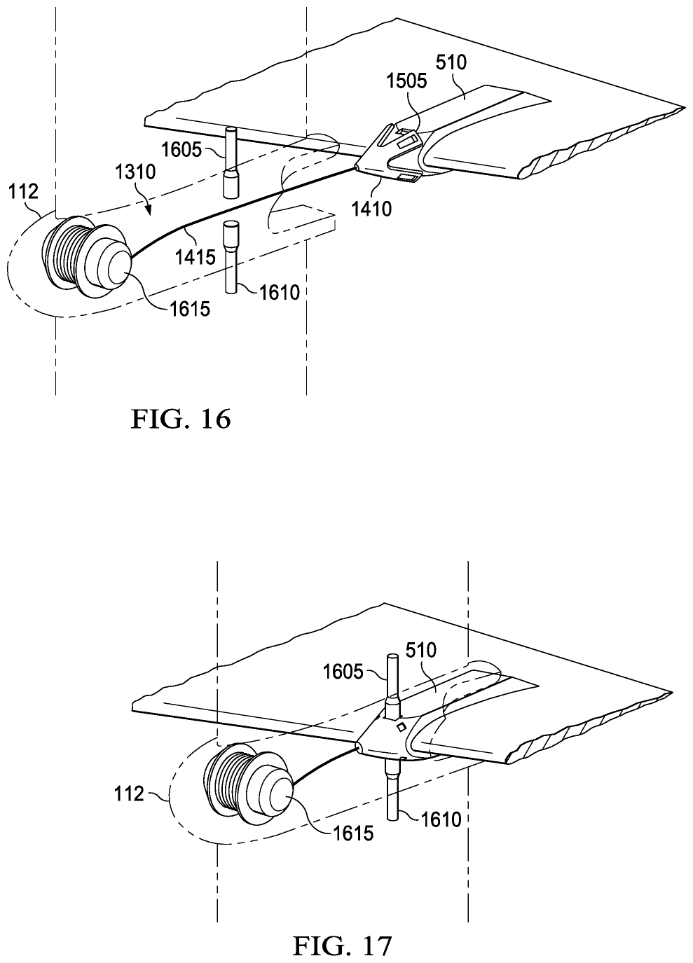

FIG. 13 illustrates a perspective view of carriage 100 engaging with aircraft 500. Coupling mechanisms 1305, 1310 are used to engage the aircraft 500 with carriage 100. Coupling mechanisms 1305, 1310 may include a wench assembly partially disposed within housing 110, 112 as described below in FIG. 16. Once the coupling mechanisms 1305, 1310 are coupled to aircraft 500 at coupling elements 505, 510, carriage 100 pulls aircraft 500 in until the carriage 100 and the aircraft 500 are in the joined configuration 900.

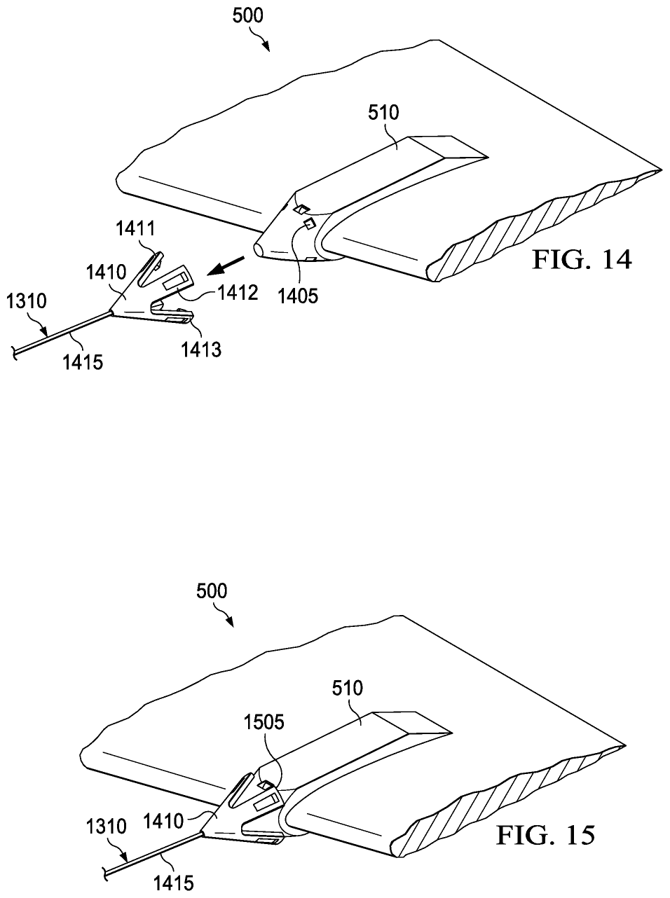

FIG. 14 illustrates how coupling mechanism 1310 may be coupled to coupling element 510. Coupling mechanism 1310 includes a reel (shown below in FIG. 16), a line 1415 and a coupling member 1410. In one implementation, coupling member 1410 can be a reel cone. As aircraft 500 moves towards carriage 100, arms 1411, 1412, 1413 of coupling mechanism 1310 attach to corresponding grooves, e.g., groove 1405, of coupling element 510. Coupling element 510 may further include lock groove(s), e.g., groove 1505, that correspond to locking component(s) of carriage 100 as described below in FIG. 16 and FIG. 17. FIG. 15 shows coupling mechanism 1310 once the coupling with coupling element 510 is complete.

FIG. 16 shows carriage 100 engaged with aircraft 500 just prior to entering a joined configuration 900. FIG. 17 shows carriage 100 engaged with aircraft 500 in the joined configuration 900. In this implementation, once coupling member 1410 has been coupled to coupling element 510, reel 1615, which is situated within housing 112, rotates to pull the aircraft 500 into the joined configuration 900. The coupling mechanism 1310, which includes reel 1615, line 1415 and coupling member 1410, is configured to operate as a wench in this implementation. Once the aircraft 500 is pulled into the joined configuration 900, as shown in FIG. 17, locking components 1605, 1610 engage with grooves, e.g., groove 1505, to lock aircraft 500 in place with carriage 100 in the joined configuration 900. When aircraft 500 is locked into place, coupling member 1410 can be released from coupling element 510.

In one implementation, aircraft 500 may enter a joined configuration 900 with carriage 100 without the aid of a wench, e.g., coupling mechanism 1310. In this implementation, the aircraft lines up coupling elements 505, 510 with housings 110, 112 and flies into joined configuration 900. Once the aircraft 500 and carriage 100 are in joined configuration 900, i.e., the coupling elements 505, 510 are in a predetermined position within the housings 110, 112, locking components, e.g., locking components 1605, 1610, engage with grooves, e.g., groove 1505, to lock aircraft 500 in place with carriage 100 in the joined configuration.

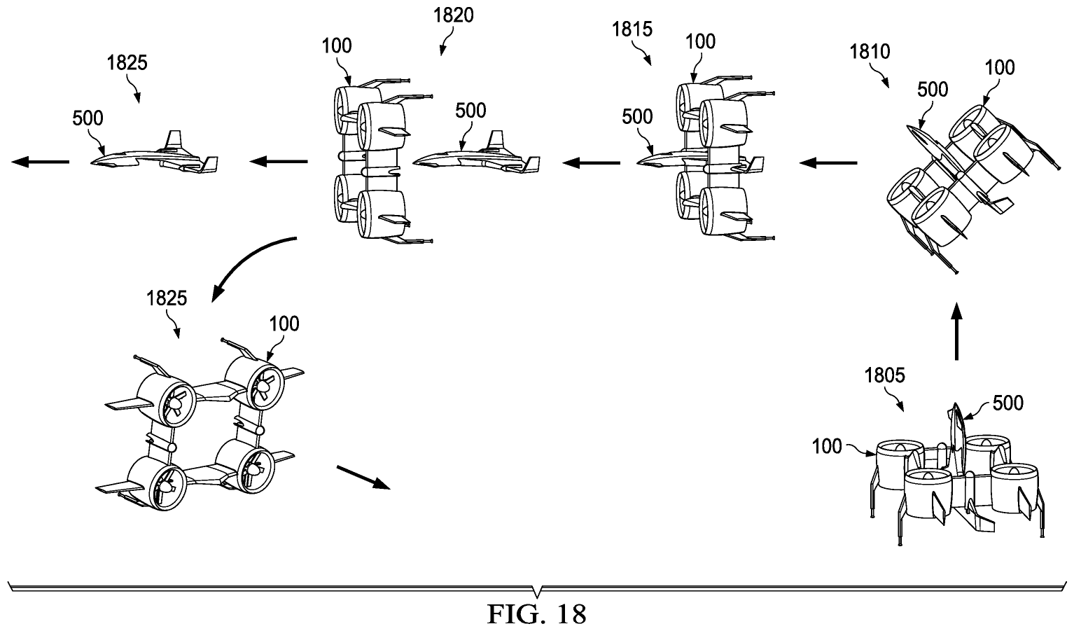

FIG. 18 shows an outbound transition, i.e., a vertical takeoff, of carriage 100 and aircraft 500. In 1805, carriage 100 and aircraft 500 are in a joined configuration 900 prior to takeoff. Vertical thrust may be provided by carriage 100 alone or in combination with aircraft 500. At 1810, carriage 100 and aircraft 500 are transitioning from vertical flight to horizontal flight. The thrust and control for transitioning can be provided by both carriage 100 and aircraft 500. At 1815, carriage 100 and aircraft 500 are still in a joined configuration and flying horizontally. At 1820, carriage 100 releases, e.g., by disengaging locking components from grooves in coupling elements 505, 510, aircraft 500 from the joined configuration 900. Aircraft 500 slows down to provide separation between aircraft 500 and carriage 100. At 1825, aircraft 500 continues along its flight path and carriage 100 lands.

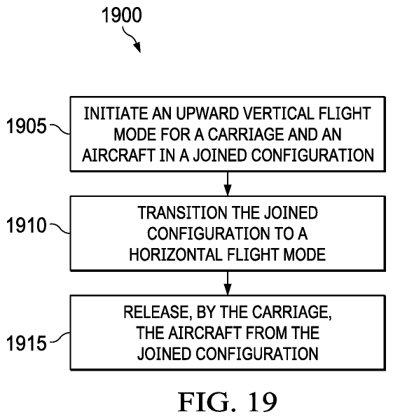

FIG. 19 illustrates a diagram of an outbound transition method 1900 in accordance with various techniques described herein. At block 1905, an upward vertical flight mode is initiated for a carriage, e.g., carriage 100, and an aircraft, e.g., aircraft 500, in a joined configuration, e.g., joined configuration 900. The thrust for the upward vertical flight mode may be provided by the carriage alone or in conjunction with the aircraft.

At block 1910, the joined configuration is transitioned to a horizontal flight mode. The thrust for the transition from upward vertical flight mode to horizontal flight mode may be provided by the carriage alone or in conjunction with the aircraft.

At block 1915, the carriage releases the aircraft from the joined configuration. The carriage and the aircraft are each in their respective horizontal flight mode once the aircraft is released from the joined configuration.

After the carriage releases the aircraft from the joined configuration, the carriage transitions to a downward vertical flight mode. The carriage lands while in the downward vertical flight mode.

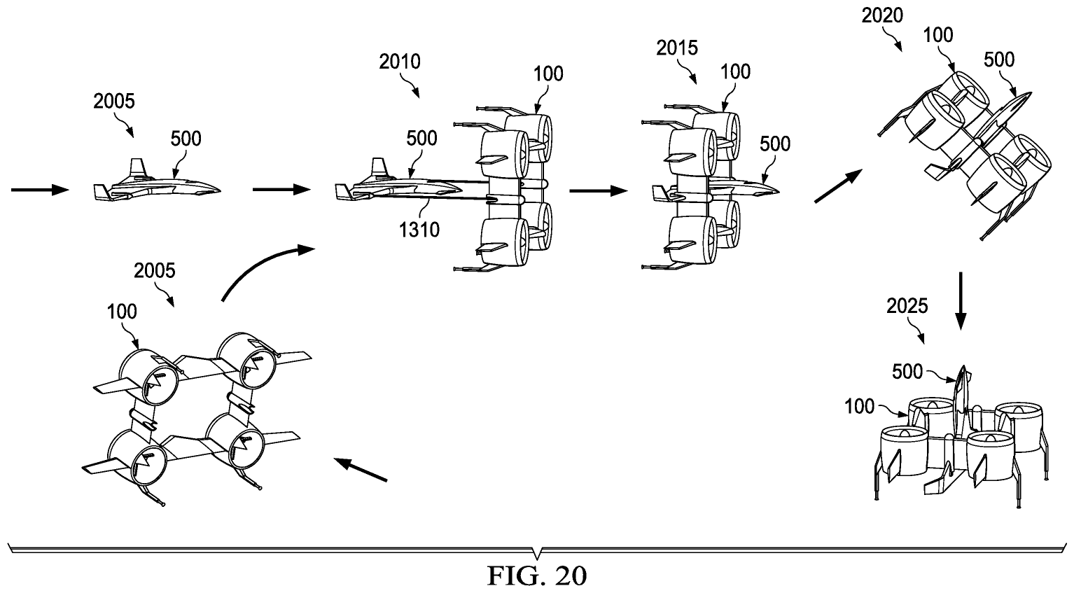

FIG. 20 shows an inbound transition, i.e., a vertical landing, of carriage 100 and aircraft 500. At 2005, carriage 100 flies to meet with aircraft 500 in mid-air. At 2010, aircraft 500 engages with carriage 100 using coupling mechanism 1310 of carriage 100. Once aircraft 500 is engaged with carriage 100, aircraft 500 throttles back and coupling mechanism 1310 is used to reel aircraft 500 into a joined configuration. Once aircraft 500 and carriage are in a joined configuration, the carriage 100 locks aircraft 500 into place, e.g., using locking components 1605, 1610. The joined configuration is shown in 2015. As described above, aircraft 500 may also fly into a joined configuration with carriage 100 without using coupling mechanism 1310. In this implementation, once the aircraft 500 flies into the joined configuration with carriage 100, carriage 100 locks aircraft 500 into place. At 2020, carriage 100 and aircraft 500 are transitioning from horizontal flight to vertical flight. The thrust and control for transitioning can be provided by both carriage 100 and aircraft 500. When carriage 100 and aircraft 500 transition to a vertical orientation for a vertical landing, vertical thrust may be provided by carriage 100 alone or in combination with aircraft 500. Item 2025 shows carriage 100 and aircraft 500 once the vertical landing has been completed.

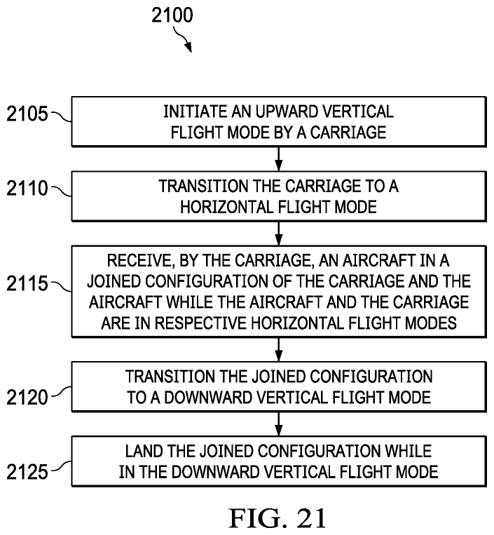

FIG. 21 illustrates a diagram of an inbound transition method 2100 in accordance with various techniques described herein. At block 2105, an upward vertical flight mode is initiated by a carriage, e.g., carriage 100. At block 2110, the carriage is transitioned to a horizontal flight mode.

At block 2115, the carriage receives an aircraft, e.g., aircraft 500, in a joined configuration, e.g., joined configuration 900, of the carriage and the aircraft while the aircraft and the carriage are in respective horizontal flight modes. Once the carriage and the aircraft are in the joined configuration, the joined configuration continues in a joined horizontal flight mode. In one implementation, the carriage includes a wench that is used to pull the aircraft into the joined configuration. In another implementation, the aircraft flies into the joined configuration. Once the

At block 2120, the joined configuration is transitioned from the joined horizontal flight mode to a downward vertical flight mode. The thrust for the transition from joined horizontal flight mode to downward vertical flight mode may be provided by the carriage alone or in conjunction with the aircraft.

At block 2125, the joined configuration lands while in the downward vertical flight mode. The thrust for downward vertical flight mode may be provided by the carriage alone or in conjunction with the aircraft.

In addition to the VTOL capabilities described above with respect to an aircraft, carriage 100 may also be employed to provide further operational conveniences. In one implementation, carriage 100 may be employed to vertically lift and move cargo or other items.

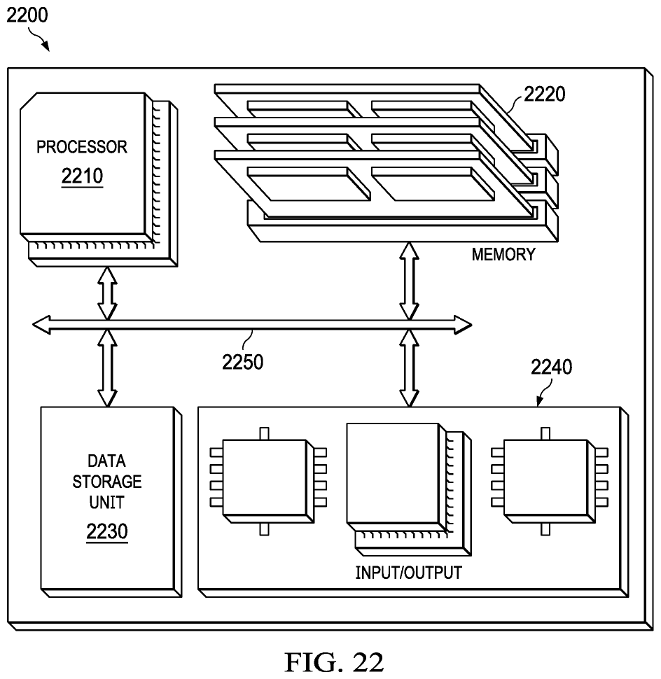

Both carriage 100 and aircraft 500 include flight controls and avionics systems. Some or all of the flight controls and avionics systems may be implemented using a hardware configuration. The hardware configuration may include, but is not limited to, an air data computer. The hardware configuration is described in more detail below in FIG. 22.

FIG. 22 illustrates a block diagram of a hardware configuration 2200 operable to provide flight controls and avionics, e.g., in carriage 100 and/or aircraft 500. The hardware configuration 2200 can include a processor 2210, a memory 2220, a storage device 2230, and an input/output device 2240. Each of the components 2210, 2220, 2230, and 2240 can, for example, be interconnected using a system bus 2250. The processor 2210 can be capable of processing instructions for execution within the hardware configuration 2200. In one implementation, the processor 2210 can be a single-threaded processor. In another implementation, the processor 2210 can be a multi-threaded processor. The processor 2210 can be capable of processing instructions stored in the memory 2220 or on the storage device 2230.

The memory 2220 can store information within the hardware configuration 2200. In one implementation, the memory 2220 can be a computer-readable medium. In one implementation, the memory 2220 can be a volatile memory unit. In another implementation, the memory 2220 can be a non-volatile memory unit.

In some implementations, the storage device 2230 can be capable of providing mass storage for the hardware configuration 2200. In one implementation, the storage device 2230 can be a computer-readable medium. In various different implementations, the storage device 2230 can, for example, include a hard disk device/drive, an optical disk device, flash memory or some other large capacity storage device. In other implementations, the storage device 2230 can be a device external to the hardware configuration 2200.

The input/output device 2240 provides input/output operations for the hardware configuration 2200. In one implementation, the input/output device 2240 can include one or more flight control and/or avionics system interfaces, sensors and/or data transfer ports.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A vertical takeoff and landing system, comprising:
a carriage having:
a thrust component configured to provide vertical and/or horizontal thrust for the carriage; and
one or more housings configured to receive an aircraft in a joined configuration of the carriage and the aircraft.

2. The vertical takeoff and landing system of claim 1, further comprising a lift component configured to provide lift for the carriage.

3. The vertical takeoff and landing system of claim 1, further comprising a plurality of struts that serve as landing gear, provide ground clearance for the carriage or both.

4. The vertical takeoff and landing system of claim 1, wherein the one or more housings include one or more coupling mechanisms configured to engage with the aircraft.

5. The vertical takeoff and landing system of claim 4, wherein the one or more coupling mechanisms comprises a wench assembly.

6. The vertical takeoff and landing system of claim 5, wherein the wench assembly comprises:
a reel;
a line coupled to the reel; and
a coupling member coupled to the line.

7. The vertical takeoff and landing system of claim 6, wherein the coupling member is configured to engage with the aircraft.

8. The vertical takeoff and landing system of claim 6, wherein the reel of the wench assembly rotates to pull the aircraft into the joined configuration with the carriage.

9. The vertical takeoff and landing system of claim 8, wherein the one or more housings include one or more locking components configured to engage with the aircraft when the carriage is in the joined configuration with the aircraft.

10. The vertical takeoff and landing system of claim 1, wherein the one or more housings are configured to receive the aircraft when the aircraft flies into the joined configuration with the carriage.

11. The vertical takeoff and landing system of claim 10, wherein the one or more housings include one or more locking components configured to engage with the aircraft when the carriage is in the joined configuration with the aircraft.

12. A method for providing carriage-based vertical takeoff, comprising:
initiating an upward vertical flight mode for a carriage and an aircraft in a joined configuration;
transitioning the joined configuration to a horizontal flight mode; and
releasing, by the carriage, the aircraft from the joined configuration.

13. The method of claim 12, further comprising:
transitioning the carriage to a downward vertical flight mode; and
landing the carriage while in the downward vertical flight mode.

14. The method of claim 12, wherein thrust for the upward vertical flight mode is provided by the carriage in the joined configuration.

15. The method of claim 12, wherein thrust for the upward vertical flight mode is provided by the carriage and the aircraft in the joined configuration.

16. A method for providing carriage-based vertical landing, comprising:
initiating an upward vertical flight mode by a carriage;
transitioning the carriage to a horizontal flight mode;
receiving, by the carriage, an aircraft in a joined configuration of the carriage and the aircraft while the aircraft and the carriage are in respective horizontal flight modes;
transitioning the joined configuration to a downward vertical flight mode; and
landing the joined configuration while in the downward vertical flight mode.

17. The method of claim 16, wherein receiving, by the carriage, the aircraft in the joined configuration comprises using a wench to pull the aircraft into the joined configuration.

18. The method of claim 16, wherein receiving, by the carriage, the aircraft in the joined configuration comprises the aircraft flying into the joined configuration.

19. The method of claim 16, wherein thrust for the downward vertical flight mode is provided by the carriage.

20. The method of claim 16, wherein thrust for the downward vertical flight mode is provided by the carriage and the aircraft.
